(19) United States
(12) Patent Application Publication
(10) Pub. No.: US 2011/0020610 A1
(43) Pub. Date: Jan. 27, 2011

(54) FABRIC WALLCOVERING SYSTEM

(76) Inventors: Allan Marshall, Hudson, OH (US); William R. Bell, Ethelsville, AL (US); Barry Goldslager, Hudson, OH (US); Robert Moore, Starkville, MS (US); Otis Wilmuth Jr. Allen, Columbus, MS (US)

Correspondence Address: OMNOVA Solutions Inc.;#4, 175 Ghent Road, Fairlawn, OH, 44333, US

(21) Appl. No.: 12/919,623

(22) PCT Filed: Feb. 23, 2009
(86) PCT No.: PCT/US09/01136

§ 371 Date: Oct. 7, 2010

Related U.S. Application Data
(60) Provisional application No. 61/067,574, filed on Feb. 29, 2008.

(51) Int. Cl. D06N 7/06; D04H 13/00; E04F 13/00; B32B 5/04; B05D 5/06

(52) U.S. Cl. 428/172; 428/219; 428/212; 428/196; 427/271

(57) ABSTRACT

Single ply wallcovering comprise a fabric comprising hydroentangled polymeric microfilaments. The fabric has a tear strength of at least about 25 MD and at least about 25 CD as determined by ASTM D 751, method A, and the fabric additionally has a breaking strength of at least about 50 MD and at least about 55 CD as determined by ASTM D 751, Grab method. The wallcovering comprises a decorative image, a fire retardant and a stain resistance treatment. The wallcovering has a basis weight of from about 4 to about 22 oz/yd². Methods for making the wallcovering are also described.

This application claims the benefit of U.S. Provisional Application Ser. No. 61/067,288 filed on Feb. 29, 2008, entitled “FABRIC WALLCOVERING SYSTEM,” which application is incorporated herein by reference in its entirety.

### FIELD OF THE INVENTION

The present invention relates to wallcoverings. More specifically, the invention relates to wallcoverings comprising fabric that exhibit high performance characteristics.

### BACKGROUND OF THE INVENTION

Wallcoverings are known and can be applied/laminated to a wall-surface (e.g, wallboard) so as to provide aesthetic appeal, and additionally some protective benefits as well, such as stain resistance, flame resistance, and physical protection.

Wallcoverings come in a number of varieties. Consumers are familiar with printed paper wallpaper, which provides excellent aesthetic appeal, but which is not durable. In a commercial setting or for specialized applications, a more durable wallcovering is needed, and different materials are called for. Most commercial wallcoverings comprise PVC film, usually backed by fabric. There are three general categories of fabric-backed vinyl wallcovering—Type I, Type II, and Type III, which refer to the weight and performance associated with the wallcoverings in these categories.

Type I is a light-duty wallcovering, and typically is provided at a weight of less than about 15 oz. per linear yard (based on a 54″ width). This grade of wallcovering provides some protection, and is recommended for use in corridors or offices where moderate traffic is expected. Type II wallcovering is a medium-duty wallcovering. It weighs between 20 and 32 oz. per linear yard (based on a 54″ width) and is produced on a woven or non-woven fabric backing. Type II is considered the “work-horse” among vinyl wallcoverings and is typically specified for areas where greater than normal traffic and surface abrasion is evident or expected. It is ideal for offices, hospital wards, public areas and rooms in hotels, lounges, dining rooms, public corridors and classrooms. Type Ill is a heavy duty wallcovering recommended as wall protection for areas exposed to extraordinarily hard use.

Nonwoven textiles, such as described in U.S. Pat. No. 5,970,583, are known for use in automobile interiors, for interior or exterior furnishings, for the fabrication of lining surfaces and the intermediate layers of shoe components, for the manufacture of the exterior parts and linings of luggage and handbags; for the fabrication of clothing or clothing linings; for the fabrication of cloths and composite products for domestic and industrial cleaning, as well as for clean rooms; and the like.

It is desirable to provide new wallcovering products made from different and lighter weight materials that will provide satisfactory aesthetic and protective properties.

### SUMMARY OF THE INVENTION

As noted above, the Type II designation of wallcovering has been established for defining a standard of performance, and especially protective performance for wallcovering, and is defined around a construction design providing a PVC film laminated to a fabric backing. It was previously believed that such a laminate construction was necessary to obtain the desired performance properties for the wallcovering. It has surprisingly been found that the wallcoverings can achieve Type II wallcovering performance standards (US Federal Standard CCC-W-408D issued Jan. 14, 1994) without using a two ply construction comprising PVC polymer film. Further, the protective performance of the present wallcovering is surprisingly achieved by a wallcovering construction that weighs less than the conventional vinyl wallcoverings available on the market.

The present invention provides a single ply wallcovering comprising a fabric comprising hydroentangled polymeric microfilaments. The fabric has a tear strength of at least about 25 MD and at least about 25 CD as determined by ASTM D 751, method A, and the fabric additionally has a breaking strength of at least about 50 MD and at least about 55 CD as determined by ASTM D 751, Grab method. The wallcovering comprises a decorative image, a fire retardant and a stain resistance treatment. The wallcovering has a basis weight of from about 4 to about 22 oz/yd².

Because of the selection of materials possible with the present invention, the resulting wallcovering may exhibit low VOC emissions, and additionally may be made as a 100% PVC free product, and also may be made as a 100% recyclable product. Surprisingly, the present wallcovering may be engineered for Type II wallcovering performance (even though it is not a PVC product), and is exceptionally resistant to stains and tears while exhibiting an NFPA 286 Class A fire rating.

The exceptional performance of the present wallcovering at lower weight reduces the fuel and expense required to handle and particularly to ship the wallcovering product, and also eases installation of the product because it is easier to handle during installation. The wallcovering advantageously does not contain PVC polymer. PVC-free products are preferred by some customers. Additionally, because the present wallcovering is only one ply, it is easier and more fuel efficient to manufacture.

### BRIEF DESCRIPTION OF THE DRAWINGS

The accompanying drawing, which is incorporated in and constitute a part of this application, illustrate several aspects of the invention and together with a description of the embodiments serve to explain the principles of the invention. A brief description of the drawings is as follows:

FIG. 1 is a schematic process flow diagram of one preferred embodiment of the present method of preparation.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

As noted above, the present wallcovering is a single ply construction, meaning that the wallcovering is not a laminate of two separate constructions, such as a film laminated to a fabric backing. The present wallcovering is instead a single ply fabric. It is specifically contemplated that the fabric wallcovering of the present invention will have coatings applied thereto, including decorative images, fire retardant and stain resistant coatings or treatments. These coatings or treatments, however, are integral with the fabric and do not form a distinct separate ply.

The fabric of the wallcovering of the present invention comprises hydroentangled polymeric microfilaments that form a nonwoven lap of filaments. The fabric is sufficiently hydroentangled to provide a fabric having a tear strength of at least about 25 MD and at least about 25 CD as determined by ASTM D 751, method A. The fabric additionally has a breaking strength of at least about 50 MD and at least about 55 CD as determined by ASTM D 751, Grab method.

Preferably, the fabric is a nonwoven lap of continuous filaments, crimped or not, obtained by means of a direct controlled spinning process, with a weight between 5 g/m² and 600 g/m², and formed, after napping, of longitudinally separable composite filaments, characterized in that the composite filaments have a filament number (i.e., titer, yarn count) between 0.3 dTex and 10 dTex, and are each formed of at least three elementary filaments and at least two different materials, and comprise among them at least a plane of separation or cleavage, each elementary filament having a filament number between 0.005 dTex and 2 dTex, with the ratio of the cross-sectional area of each elementary filament to the total cross-sectional area of the unitary filament being between 0.5% and 90%. Examples of such fabrics are described in U.S. Pat. No. 5,970,583, which is incorporated by reference for all purposes. Preferred such fabrics are available from Carl Freudenberg KG, Germany as Evolon® fabrics.

Preferably, the nonwoven lap is prepared by placing the fibers in a web using a suitable operation such as extrusion/spinning, drawing/cooling, and napping, and additionally bonding and/or consolidating the web by a hydroentanglement process.

The polymeric microfilaments are preferably prepared from polymers selected from polyesters, nylons, rayons, thermoplastic polyolefins and copolymers and blends thereof. Preferably, the polymeric microfilaments are prepared from polymer blends that are selected from the blend combinations of (polyester/polyamide), (polyamide/polyolefin), (polyester/polyolefin), (polyurethane/polyolefin), (polyester/polyester modified by at least one additive), (polyamide/polyamide modified by an additive), (polyester/polyurethane), (polyamide/polyurethane), (polyester/polyamide/polyolefin), (polyester/polyester modified by at least one additive/polyamide), and (polyester/polyurethane/polyolefin/polyamide).

The different polymer materials are preferably provided in the form of composite filaments, which are separated into elementary filaments and provided with an optional asymmetric shape (such as a crimp) by treatment such as thermal, chemical or physical treatment, or combinations thereof. Examples of thermal treatment include application of heat by tunnel oven, boiling water, steam, hot cylinder, microwaves, or infrared energy. Examples of physical treatment particularly include hydroentanglement. After separation, the elementary filaments preferably have different cross-sectional patterns to provide elementary filaments of clearly different filament numbers. To promote separation of the composite elements into elementary filaments, the composite filaments may contain a hollow longitudinal tubular cavity, centered or not with respect to the median axis of the composite filaments. To further consolidate the structure of the nonwoven lap, the composite filaments may present a latent or spontaneous crimp resulting from an asymmetry in the behavior of the filaments with respect to their median longitudinal axis, the crimp being activated or accentuated, where appropriate, by an asymmetry in the geometry of the configuration of the cross-section of the composite filaments.

The cohesion and mechanical resistance of the nonwoven lap can, moreover, be substantially increased by binding the elementary filaments by thermobonding one or more of them formed of a polymer material with a lower melting point, by calendering with smooth or engraved hot rollers, by passage through a hot-air tunnel oven, by passage over a through-cylinder, and/or by the application of a binding agent contained in a dispersion, solution, or in the form of a powder.

In a variant, consolidation of the lap can also be achieved, for example, by hot calendering, prior to any separation of the unitary composite filaments into elementary filaments or microfilaments, the separation being effected after consolidation of the lap.

Preferably, the fabric is provided at an uncoated weight of from about 160 grams/m² to about 250 grams/m², more preferably from about 160 grams/m² to about 180 grams/m², in order to provide sufficient body so that the fabric does not fall over during application. It has been found that fabrics having a uncoated weights that are lower than about 160 grams/m² tend to be flimsy and do not meet handleability expectations for wallcoverings.

In one embodiment of the present invention, the exposed face of the wallcovering is preferably provided with a decorative image, preferably by printing with a suitable ink to form desirable decorative patterns and designs. Such inks are well known and can be applied by various methods of printing such as by gravure printing; flexographic printing; laser etching; offset printing; dye sublimation printing and transfer; xerographic printing; solvent, aqueous, EB and UV ink jet printing; thermographic printing and/or solvent, aqueous, EB, UV and powder coat coating, screen printing, and the like. The printing operation may be repeated many times, as needed, to vary the colors and designs. The image can be a color, a pattern of one or more colors, a representation of figures and the like and/or text. Preferably, the wallcovering of the present invention is prepared by a gravure process due to exceptional speed and economic production of the final product.

A stain resistant component is applied to the wallcovering of the present invention, preferably in a top-finish composition. The preferred top-finish composition is a water based composition comprising fluorocarbon components with dispersant system formulated to be stable in a treatment bath, but suitable for application by a gravure process. The composition has a solids content of about 20 to 35%. The fluorocarbon is an acrylate based polymer, preferably having pendent fluorinated groups with a carbon chain length of equal to or less than six carbons. Water and oil repellant finishes are available under the Freepel® Repellants brand from Emerald Performance Materials and X-cape® DRC from OMNOVA Solutions, Inc. The composition is of the type formulated for dip and nip coating application of the composition to the fabric, but surprisingly need only be applied by a gravure process to only the printed side of the fabric.

Additional examples of fluoropolymers that may be used in this application are well known to those of ordinary skill in the art and include the fluorochemical textile treating agents. Preferably, the fluoropolymer comprises perfluorinated or highly fluorinated functionalities, wherein pendent fluorinated groups have a carbon chain length of equal to or less than six carbons. Such short chain fluorinated moieties have been shown to have low bioaccumulation in living organisms. Perfluorocarbon moieties of up to four carbon atoms in length are thus particularly useful. Alternatively, acrylic, polyether and epoxy based materials can be made utilizing fluorinated moieties based on heptafluorobutyl, perfluoropropyl, and trifluoro ethyl pendant groups that are non-bioacumulative.

The stain resistant containing top-finish is applied at much higher wet coating weights than is conventional in wallcovering printing operations. In order to accomplish this high wet coating weight application, specialized gravure printing rollers are required. Surprisingly, it was found that application of a higher solids stain resistant finish composition at a lower wet coating weight to achieve the same effective dry coating weight does not provide the same degree of performance properties. While not being bound by theory, it is believed that larger amount of liquid provides full distribution of the active components through the fabric.

It has surprisingly been discovered that, while it is important to coat the wallcovering with a large amount of stain resistant material (i.e. an application rate of from about 20 to about 60 lbs per square yard, and more preferably about 35-45 lbs per square yard (normal stain resistant application rate is about 5 lbs/yd)) the resulting wallcovering does not feel stiff or “boardy.” Additionally, this class of stain resistant material is conventionally used for apparel, where it is applied by a “dip and strip” process. In contrast, the present invention applies the top-finish using a gravure-style application drum to achieve the desired application rate on one side of the fabric.

Additionally, it was surprisingly found that the top-finish needed to be applied at a high wet application rate (from about 20 to about 60 lbs per square yard, and more preferably about 35-45 lbs per square yard), but at a relatively low solids content (from about 20 to 35% solids). Thus, the process used for application of the top-finish to the fabric preferably uses a 25 Quad drum. Attempts to use a different drum (i.e. a 50 Quad cylinder) that applied half as much liquid but using a higher concentration to achieve the same dry material application rate failed to produce a product that would provide satisfactory stain resistance.

In order to impart flammability properties, any suitable flame retardant may be incorporated in the wallcovering construction. By use of the fabric as described herein with judicious selection of flame retardant materials as will now be readily appreciated by the skilled artisan, a wallcovering of Type II performance quality is prepared that meets the fire performance criteria described herein.

The flame retardant may be a reactive flame retardant, i.e. a component that is chemically built into a polymer molecule. The polymer molecule bearing the flame retardant component may be a component of the fabric itself, or a polymeric component of a coating applied to the fabric, such as in particular as a polymeric component of the top-finish. Alternatively, the flame retardant may be an additive flame retardant, i.e. that is not reactively bound to a polymer per se. Additive flame retardants similarly may be provided at any step in the process of manufacturing the wallcovering, but preferably are incorporated as a component of the top-finish.

Examples of flame retardants include inorganic flame retardants, such as metal hydroxides (e.g. aluminum trihydroxide, magnesium hydroxide), ammonium polyphosphate and red phosphorus. Inorganic compounds such as zinc borate can function as a flame retardant, smoke suppressant and anti-arcing agent in condensed phase. Other inorganic flame retardants, including ammonium sulfamate and ammonium bromide.

An important category of flame retardants is the halogenated products, which are based primarily on chlorine and bromine. Examples of preferred halogenated fire retardants include tetrabromobisphenol A, decabromodiphenyl ether and hexabromocyclododecane. Chlorine-containing flame retardants belong to three chemical groups: aliphatic, cycloaliphatic and aromatic compounds. Chlorinated paraffins are particularly preferred aliphatic chlorine-containing flame retardants.

Another category of flame retardants is the organophosphorus products, including phosphate esters, polyols, phosphonium derivatives and phosphonates. The phosphate esters include trialkyl derivatives such as triethyl or trioctyl phosphate, triaryl derivatives such as triphenyl phosphate and aryl-alkyl derivatives such as 2-ethylhexyl-diphenyl phosphate. A preferred flame retardant is Pyrosan SYN, which is composed of dialkyl alkyl phosphonate esters.

In addition, nitrogen-based flame retardants such as melamine, melamine cyanurate, other melamine salts and guanidine compounds are contemplated for use in the present invention.

The present invention may additionally comprise fire retardant synergists, such as antimony trioxide. Other types of fire retardant materials may also be employed in the present invention, e.g., char forming agents.

The top-finish of the present invention preferably additionally comprises resin materials conventional to textile finishing materials, such as water soluble melamine formaldehyde condensate resins.

Preferably, the present wallcovering passes ASTM E-84: Standard Method of Test of Surface Burning Characteristics of Building Materials, wherein the test is carried out on ½″ Type “X” gypsum board.

In a particularly preferred embodiment of the present invention, the stain resistant materials and the fire resistant materials are applied in a top-finish application after application any color and image aspects of the wall covering, but before any optional embossing of the wallcovering.

Preferred top-finishes are aqueous compositions that comprise fire retardant, stain resistant component, resin, and catalysts, and additionally comprises from about 60 to 80% of water by weight. In another embodiment, preferred top-finishes are aqueous compositions that comprise fire retardant, defoamer, stain resistant component, melamine resin, biocide, indicators and catalysts. Preferably water is about 60 to 80% of the top-finishing composition by weight.

Surprisingly, the present wallcovering preferably exhibits exceptional resistance to stains and scrubability performance as determined by Type II wallcovering performance standards (US Federal Standard CCC-W-408D issued Jan. 14, 1994), even though the construction is a single ply fabric and not a two ply construction comprising PVC polymer film. Thus, the present wallcovering preferably passes the scrubability evaluation set forth in the above standard after 200 cycles, and preferably after 400 cycles. Similarly, the present wallcovering preferably passes the stain resistance evaluation for the stain reagents 1-12 as set forth in the above standard. By use of the fabric as described herein with judicious selection of stain resistant components and top finish components as will now be readily appreciated by the skilled artisan, a wallcovering of Type II performance quality is prepared that meets the stain resistance performance criteria and scrubability performance criteria described herein. Further, the present wallcovering preferably exhibits an NFPA 286 Class A fire rating, again despite being a single ply fabric construction.

As noted above, the present invention provides significant reduction in release of VOCs to the environment as compared to certain other wallcovering systems. Environmental concerns dictate that such polymer coatings and compositions be used with a minimum of release of unwanted organic materials to the air. Volatile Organic Compounds (“VOCs”) contribute to pollution of our planet and otherwise can diminish the quality of life. According to the definition in the European Union VOC-directive, a compound is volatile if the vapor pressure is higher than 0.1 mbar at 20° C. The wallcovering of the present invention makes it possible to provide a Type II level wallcovering that exhibits minimum release of VOCs to the atmosphere. Thus, by use of the fabric as described herein with judicious selection of inks and other treatment chemicals as will now be readily appreciated by the skilled artisan, a wallcovering of this performance quality is prepared that emits less than 0.5 mg/m³ Total VOCs as determined by the Greenguard Emission Criteria published in 2005, (GREENGUARD Environmental Institute, Marietta, Ga.). In a preferred embodiment, a wallcovering of Type II performance quality is prepared that emits less than 0.22 mg/m³ Total VOCs, which meets a significant component of the Emission Criteria for Children and Schools as established by the GREENGUARD Environmental Institute. Preferably, the wallcovering of Type II performance quality meets all aspects of the Emission Criteria for Children and Schools as shown in Table 1 below:

TABLE 1

| Component | Emission Standard |
|---|---|
| Individual VOCs | ≦1/100 TLV and ≦½ CA chronic REL |
| Formaldehyde | ≦0.0135 ppm/13.5 ppb |
| Total VOCs | ≦0.22 mg/m³ |
| Total Aldehydes | ≦0.043 ppm/43 ppb |
| Total Phthalates | ≦0.01 mg/m³ |
| Total Particles | (≦10 μm) ≦ 0.02 mg/m³ |

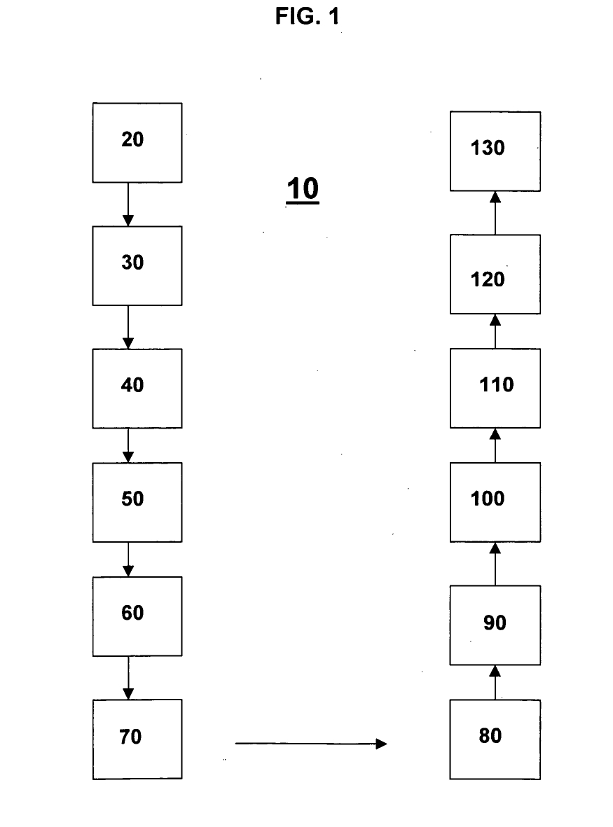

Turning now to the drawing for further illustration, FIG. 1 is a schematic process flow diagram of one preferred embodiment of the present method of preparation.

In this process 10, a fabric comprising polymeric hydroentangled microfilaments is provided having an initial uncoated weight of about 170 grams/m². The fabric is unwound from a source roller at unwind station 20 and carried by idler rolls into the first step of the process, the pre-heat station 30. In an embodiment of the present invention, the fabric is heated on drums to provide a consistent temperature print surface for subsequent processing. First printing station 40 preferably is a blotch print station. If desired, a base or background color is applied as a blotch coating. This blotch coating is dried by inter-stage ovens 50 before reaching the next print station 60. Prints are applied on multiple print stations 60 and 80 to achieve desired visual appearance. Optionally, one to four or more print stations can be used in the depending on desired aesthetics. Each print is dried by an inter-stage oven 70 and 90 so that the preceding print is dry before the substrate reaches the next print station.

A top-finish is applied at top-finish print station 100, preferably by a gravure cylinder that is configured as a 25 quad to apply required amount of top-finish. After application of the top-finish, the substrate travels through a drying station that preferably removes approximately 70% of the water and prepares the surface for final drying at the emboss station 120.

At emboss station 120, the coated fabric is preferably placed in direct contact with a large pre-heat drum from the back side of the substrate, and further heated by infrared heaters to maintain the web temperature until the material reaches an embossing nip that presses a texture into the substrate. Multiple textures can be used depending upon aesthetic requirements for the final product. The coated and embossed fabric substrate is a finished product at this point, and is taken up at wind-up station 130.

Subsequent processing steps can optionally be carried out, including slitting and final packaging in appropriate sizes for application at the desired end location.

The product as described herein has been generically described as a wallcovering, in a non-limiting sense. It will be understood that the wallcovering of the invention is preferably applied to a wall, but alternatively may be applied to any other substrate such as a floor, ceiling, container surface or other such substrate to provide an aesthetically pleasing, decorative covering, or a protective covering. They can be installed by following standard installation procedures; no special tooling or training is required. Additionally, their low-maintenance properties contribute to an even higher value over the life of the products.

The wallcovering of the present invention may easily be applied to a substrate using an adhesive. In one embodiment of the present invention, the wallcovering is preferably provided in prepasted form, e.g. provided in roll form with adhesive already coated on one side of the wallcovering. The adhesive may be any appropriate adhesive for adhering a wallcovering to a desired substrate.

In a preferred embodiment of the present invention, the wallcovering laminate is provided in sheet dimensions appropriate for use as wallcovering materials. In one embodiment, the wallcovering laminate is provided in roll form suitable for residential application and having a lengthwise dimension of at least about 24 feet (or alternatively at least about 30 feet), and a width dimension of at least about 20 inches (or alternatively at least about 27 inches or 36 inches). In another embodiment, the wallcovering laminate is provided in roll form suitable for commercial application and having a width of about 48 inches or 54 inches, and a length of at least about 30 feet.

As noted above, the wallcovering has a finished basis weight of from about 4 to about 22 oz/yd². This relatively low basis weight as compared to PVC wallcoverings is significantly advantageous, because excellent strength properties are afforded at a relatively low weight. In an embodiment of the present invention, the wallcovering has a basis weight of less than about 9 oz/yd². In another embodiment, the wallcovering has a basis weight of from about 5-7 oz/yd².

All patents, patent applications (including provisional applications), and publications cited herein are incorporated by reference as if individually incorporated. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A single ply wallcovering comprising a fabric comprising hydroentangled polymeric microfilaments; the fabric having a tear strength of at least about 25 MD and at least about 25 CD as determined by ASTM D 751, method A, and the fabric additionally having a breaking strength of at least about 50 MD and at least about 55 CD as determined by ASTM D 751, Grab method; the wallcovering comprising a decorative image, a fire retardant and a stain resistance treatment; and wherein the wallcovering has a basis weight of from about 4 to about 22 oz/yd².

2. The wallcovering of claim 1, wherein the fabric has an uncoated weight of from about 160 grams/m² to about 250 grams/m².

3. The wallcovering of claim 1, wherein the fabric has an uncoated weight of from about 160 grams/m² to about 180 grams/m².

4. The wallcovering of claim 1, wherein the polymeric microfilaments are prepared from polymers selected from polyesters, nylons, rayons, thermoplastic polyolefins and copolymers and blends thereof.

5. The wallcovering of claim 1, wherein the polymeric microfilaments are prepared from polymer blends that are selected from the blend combinations of (polyester/polyamide), (polyamide/polyolefin), (polyester/polyolefin), (polyurethane/polyolefin), (polyester/polyester modified by at least one additive), (polyamide/polyamide modified by an additive), (polyester/polyurethane), (polyamide/polyurethane), (polyester/polyamide/polyolefin), (polyester/polyester modified by at least one additive/polyamide), and (polyester/polyurethane/polyolefin/polyamide).

6. The wallcovering of claim 1, wherein the image is provided by gravure printing ink.

7. The wallcovering of claim 1, wherein the stain resistance treatment is provided by a top-finish that is a water based composition comprising fluorocarbon components.

8. The wallcovering of claim 1, wherein the wallcovering has a basis weight of less than about 9 oz/yd².

9. The wallcovering of claim 1, wherein the wallcovering has a basis weight of from about 5-7 oz/yd².

10. The wallcovering of claim 1, wherein the wallcovering is embossed.

11. The wallcovering of claim 1, wherein the wallcovering is a 100% PVC free product.

12. The wallcovering of claim 1, wherein the wallcovering passes the scrubability evaluation set forth US Federal Standard CCC-W-408D issued Jan. 14, 1994 after 200 cycles.

13. The wallcovering of claim 1, wherein the wallcovering passes the scrubability evaluation set forth US Federal Standard CCC-W-408D issued Jan. 14, 1994 after 400 cycles.

14. The wallcovering of claim 1, wherein the wallcovering passes the stain resistance evaluation for the stain reagents 1-12 as set forth in US Federal Standard CCC-W-408D issued Jan. 14, 1994.

15. The wallcovering of claim 1, wherein the wallcovering exhibits an NFPA 286 Class A fire rating.

16. A method of making a wallcovering comprising:
a) providing a fabric comprising polymeric hydroentangled microfilaments;
b) printing the fabric with a decorative image;
c) applying a top-finish composition that is a water based composition comprising fluorocarbon components to the printed side of the fabric by gravure application process at coating weight of from about 20 to about 60 lbs per square yard, the top-finish composition having a solids content of 20 to 35%; and
d) embossing the coated fabric to form a wallcovering having a basis weight of from about 4 to about 22 oz/yd².

17. The method of claim 16, wherein the top-finish composition is applied to the printed side of the fabric at coating weight of from about 35 to about 45 lbs per square yard.

18. The method of claim 16, wherein the top-finish composition is applied to the printed side of the fabric by a 25 Quad drum.

19. The method of claim 16, wherein the top-finish composition comprises fire retardant, stain resistant component, resin, and catalysts, and additionally comprises from about 60 to 80% of water by weight.
